(19) United States
(12) Patent Application Publication
(10) Pub. No.: US 2026/0135033 A1
(43) Pub. Date: May 14, 2026

(54) METHOD FOR ASSEMBLING MAGNETS USING HALBACH ARRAY MAGNETIC FIELDS AND EQUIPMENT THEREOF

(71) Applicants: Hyundai Motor Company, Seoul (KR); Kia corporation, Seoul (KR)

(72) Inventor: Seongjun Park, Hwaseong-si (KR)

(21) Appl. No.: 19/287,199

(22) Filed: Jul. 31, 2025

(30) Foreign Application Priority Data
Nov. 8, 2024 (KR) 10-2024-0157701

(51) Int. Cl. H01F 41/02

(52) U.S. Cl. CPC H01F 41/0266

(57) ABSTRACT

In an embodiment a method for assembling magnets includes assembling an array jig and an alignment jig, the alignment jig having a cylindrical shape with a rotary axis, placing a plurality of guide pins in a placement groove formed between the alignment jig and the array jig, the plurality of guide pins forming a pin structure, placing a plurality of magnets at first assembly spaces between the plurality of guide pins in the placement groove, removing the plurality of guide pins from the placement groove providing second assembly spaces, placing circumferential magnets at the second assembly spaces, pressing upper ends of the plurality of magnets and the circumferential magnets to align all array magnets according to a specified height, curing a bonding material between the aligned array magnets, and separating the alignment jig from the array magnets.

### CROSS-REFERENCE TO RELATED APPLICATIONS

This application claims priority to and the benefit of Korean Patent Application No. 10-2024-0157701 filed with the Korean Intellectual Property Office on Nov. 8, 2024, the entire contents of which are incorporated herein by reference.

### TECHNICAL FIELD

The present invention relates to a method for assembling magnets using Halbach array magnetic fields and an equipment thereof, and more particularly, to a method for assembling magnets using Halbach array magnetic fields and an equipment thereof for a rotor of a motor of an electric vehicle.

### BACKGROUND

In general, a driving motor of an electric vehicle EVx includes a stator which receives electric energy from a battery and generates a rotating magnetic field, and a rotor which rotates by the rotating magnetic field generated by the stator.

Among them, the rotor receives power and converts the rotating magnetic field generated by the stator into driving energy, and to this end, has a structure in which a plurality of magnetic substances are arranged on a circumference of a cylindrical rotor (rotor hub). In this case, the plurality of magnets can be assembled in a circular Halbach array form in order to amplify a magnetic field in a direction in which the stator is present.

Such a Halbach array mode has an advantage in that the magnetic field of the magnetic substance can be reinforced, but has a disadvantage in that when a magnetized magnetic substance is assembled to the rotor, assembling is difficult by mutual pushing repulsion in terms of manufacturing.

For example, the Halbach array mode of a related art includes a magnetized permanent magnet assembling method and a non-magnetized permanent magnet assembling method.

A magnetized permanent assembling method of the former (also referred to as a pre-magnetization method) is an assembly mode of manually bonding a permanent magnet in which an array is difficult by a magnetized magnetic force and automation implementation is difficult to the rotor one by one.

However, since the former is a mode of individually bonding the magnetized permanent magnet one by one, the former has a disadvantage in that a lot of time is required for curing a bond material, and as a result, manufacturing productivity of a rotor deteriorates. Further, there is also a disadvantage in that the permanent magnet flows by the repulsion until the bond material is cured, so it is difficult to optimize a magnetic direction. Further, it is difficult to solve a scattering problem while rotating only by the bonding between the permanent magnets, and separate a cover (carbon fiber reinforced plastic, aramid fiber, metal sleeve, etc.) is required, such that process automation is difficult.

The non-magnetized permanent magnet assembling method of the latter (also referred to as a latter method) is a method which first assembles a non-magnetized magnetic material to the rotor, and then magnetizes the non-magnetized magnetic material by applying an external magnetic field.

However, the latter has a disadvantage in that a magnetization degree of a part (e.g., a tangent direction of the rotor) where locations of the magnetic field and the magnetic material do not coincide with each other deteriorates upon magnetization after assembling, so a permanent magnet magnetization rate is lower than that in the mode of assembling the magnetized permanent magnet. That is, a feature of the Halbach array is that there is a magnet aligned in a tangent direction on a rotary axis of the rotor, and this direction is perpendicular to a magnetic flux application direction through an external electromagnet (yoke), 100% saturation cannot be made.

Further, in the case of the latter, it is impossible to distinguish the magnetic material which is not magnetized through Gauss or flux measurement. For this reason, a cost increase cause occurs, such as performing epoxy coating of another color for distinguishing in a delivered magnet company. Further, there is a problem in that when the color is wrongly coated upon delivery, mis-assembly is caused, and there is a disadvantage in that at the time of bonding after magnetization, even though a problem is confirmed, bonding cannot be restored, so burying cost increases.

The above information disclosed in this Background section is only for enhancement of understanding of the background of the invention and therefore it may contain information that does not form the prior art that is already known in this country to a person of ordinary skill in the art.

### SUMMARY

Embodiments provide a method for assembling magnets using Halbach array magnetic fields and an equipment thereof which automate magnet assembling in a specific order in a stabilized state by using Halbach array magnetic field characteristics formed in a cylindrical alignment jig and physical characteristics of a magnet.

Further embodiments provides a method for assembling magnets using Halbach magnetic fields, which includes: a step in which an array jig is assembled around a rotary axis c of an alignment jig forming a Halbach array magnetic field in a cylindrical shape; a step in which a pin structure in which a plurality of guide pins are arrayed is coupled to a placement groove between the alignment jig and the array jig; a step in which three pieces of magnets except for a circumferential magnet are preferentially assembled to a first assembly space P1 partitioned by the plurality of guide pins on the placement groove; a step in which the circumferential magnet is assembled to a second assembly space P2 secured by separating the guide pin of the pin structure; a step in which upper ends of all magnets assembled in a Halbach array are pressed to finally align all the magnets according to a height of a rotor hub; and a step in which a bond material applied between the finally aligned Halbach array magnets is collectively cured, and the Halbach array magnets are separated from the alignment jig.

Further, the step in which the pin structure is coupled may include a step in which a magnet assembly unit for three pieces of magnets is aligned on one surface of the placement groove, and a step in which the pin structure is coupled so that the first assembly space P1 is aligned according to assembly locations of the three pieces of magnets of the magnet assembly unit.

In addition, the step in which the three pieces of magnets are preferentially assembled may include a step of pushing the three pieces of magnets aligned in the magnet assembly unit through a pusher, and slidably assembling the three pieces of magnets to a first assembly space P1 of the placement groove, and a step in which when assembling of the three pieces of magnets is completed, the pusher is retreated, and the pin structure is rotated to align a next first assembly space P1.

Further, the pin structure is rotatably coupled by a rotor-shaped alignment jig or array jig, and the pin structure is rotated as the next first assembly space P1 enough to align the next first assembly space P1 based on the rotary axis c.

In addition, the method may include, after the step in which the three pieces of magnets are preferentially assembled, a step in which the bond material is applied between the three pieces of assembled magnets.

Further, the step in which the circumferential magnet is assembled includes a step in which all circumferential magnets magnetized to an outside are pre-assembled according to a specified assembly order, and a step in which when the pre-assembly is completed, all circumferential magnets magnetized to an inside are post-assembled.

In addition, the step in which all magnets are finally aligned may include a step in which a support block is assembled to a lower portion of a magnet assembled in a Halbach array by the alignment jig, a step in which the rotor hub is bonding-assembled to an inside of the magnet assembled in the Halbach array, and a step in which upper ends of all magnets are pressed through a pressing block.

Further, the step of separating the magnets may include a step of inputting the magnets of which final alignment is completed and the rotor hub into an oven, and collectively curing the magnets and the rotor hub in an assembled state to the alignment jig, and a step of separating a Halbach array magnet assembly integrally manufactured by crossing the alignment jig cooled after the curing with the pressing block.

Meanwhile, another exemplary embodiment of the present invention provides an equipment for assembling magnets using Halbach array magnetic fields, which includes: an alignment jig forming a Halbach array magnetic field through a large quantity of permanent magnets fixedly placed in a cylindrical shape; and an array jig coupled to the alignment jig around a rotary axis c and capable of assembling a plurality of magnets magnetized using characteristics of the Halbach array magnetic field according to a Halbach array.

Further, the large quantity of permanent magnets placed in the alignment jig form the Halbach array magnetic field using any one of the 8-division, 6-division, and 4-division methods, and the plurality of magnets assembled to the array jig are assembled by specifying an assembly order considering an inter-magnetic interaction and characteristics of the magnetic field according to any one of the 8-division, 6-division, and 4-division methods.

In addition, the alignment jig may be constituted by an outside diameter (OD) alignment jig forming magnetic fields concentrated on an inside direction or an inside diameter (ID) alignment jig forming magnetic fields concentrated on an outside direction according to an inner rotor or an outer rotor.

Further, the alignment jig is manufactured by an iron (Fe) material and generates an attraction of fixing a location upon assembling the magnet.

In addition, the equipment for assembling magnets using Halbach array magnetic fields may further include: a pin structure coupled to a placement groove between the alignment jig and the array jig upon assembling the magnet; a magnet assembly unit pushing and assembling three pieces of magnets except for magnets aligned in a circumferential direction a to the placement groove partitioned through the pin structure; a support block assembled to lower portions of the alignment jig and the array jig in a state in which all magnets are assembled to the placement groove after separating the pin structure; and a pressing block pressing upper ends of all magnets in a state in which the support block is assembled to finally align all magnets according to a height of a rotor hub.

Further, the magnet assembly unit may include an assembly hole formed by coupling a lower block and an upper block a pusher pushing the three pieces of magnets assembled to the assembly hole, and slidably assembling the three pieces of magnets to the placement groove.

In addition, the lower block may have a seating groove for assembling the three pieces of magnets on an upper surface, the upper block may have a guide groove on a lower surface at a location corresponding to the seating groove 0, and the assembly hole may be formed by coupling the seating groove and the guide groove.

Further, in an assembly order of specified three pieces of magnets to the assembly hole, a tangent-direction magnet is preferentially assembled to a center, and a bond material is applied to both ends of the assembled tangent-direction magnet, and then diagonal magnets are assembled in an order of a left side and a right side of the tangent-direction magnet.

Further, in the magnet assembly unit, for assembly of the three pieces of magnets within the assembly hole, the lower block may be manufactured by iron (Fe), and the upper block and the pusher may be manufactured by aluminum.

In addition, the pin structure may have a structure in which a plurality of guide pins are arrayed in a circular shape around the rotary axis c.

Further, the pin structure guides insertion locations of three pieces of magnets through a first assembly space P1 secured between the plurality of guide pins when being coupled to the placement groove, and secures a second assembly space P2 of the circumferential magnet to be assembled through a diameter size of the guide pin upon separation.

In addition, the pin structure is rotatably coupled to the alignment jig around the rotary axis c, and rotated at a predetermined angle with the alignment jig to maintain insertion points of three pieces of magnets into the magnet assembly unit constantly.

According to exemplary embodiments of the present invention, there is an effect in that a magnet is assembled in a stabilized state due to Halbach array magnetic field characteristics formed in a cylindrical alignment jig and physical characteristics of a magnet to easily manufacture a Halbach array magnet assembly without interference between magnets.

Further, there is an effect in that a magnet assembling process utilizing a pin structure and a magnet assembly unit and an optimal alignment and bond material curing process of an assembled magnet are automated to enhance productivity according to shortening a manufacturing time

Further, there is an effect in that an assembly order considering an interaction between magnets and characteristics of a magnetic field is specified for each of 8-division, 6-division, and 4-division Halbach array methods to stably assemble the magnets without shape transformation of the assembled magnet.

### BRIEF DESCRIPTION OF THE DRAWINGS

FIG. 1 illustrates a magnet assembling equipment using Halbach array magnetic fields according to an exemplary embodiment of the present invention.

FIG. 2 illustrates a configuration example of three pieces of magnets defined when applying an 8-division Halbach array according to an exemplary embodiment of the present invention.

FIG. 3 (A and B) illustrates a magnet assembly unit for assembling three pieces of magnets according to an exemplary embodiment of the present invention.

FIG. 4 illustrates a pin structure which guides assembly locations of the three pieces of magnets according to an exemplary embodiment of the present invention.

FIG. 5 is a A-A′-line cross-sectional view illustrating a final alignment state of the magnet assembled to the magnetic assembling equipment according to an exemplary embodiment of the present invention.

FIG. 6 is a flowchart schematically illustrating a method for assembling magnets using Halbach array magnetic fields according to an exemplary embodiment of the present invention.

FIG. 7 illustrates a three-piece magnet assembling process using a pin structure and a magnet assembly unit according to an exemplary embodiment of the present invention.

FIG. 8 illustrates a process in which the three pieces of magnets are first assembled, and then a circumferential magnet is assembled according to an exemplary embodiment of the present invention.

FIG. 9 illustrates a final alignment and curing process of a magnet assembled in a Halbach array according to an exemplary embodiment of the present invention.

FIG. 10 illustrates a Halbach array assembly order upon 4 division according to a first additional exemplary embodiment of the present invention.

FIG. 11 illustrates a Halbach array assembly order upon 6 division according to a second additional exemplary embodiment of the present invention.

### DETAILED DESCRIPTION OF ILLUSTRATIVE EMBODIMENTS

Hereinafter, exemplary embodiments of the present invention will be described in detail so as to be easily implemented by those skilled in the art, with reference to the accompanying drawings.

The terms used here are only for describing specific exemplary embodiments, and are not intended to limit the present invention. As used here, the singular forms are also intended to include plural forms, unless they are explicitly differently indicated by context. It will be appreciated that when terms “include” and/or “including” are used in this specification, the terms “include” and/or “including” are intended to designate the existence of mentioned features, integers, steps, operations, constituent elements, and/or components, but do not exclude the existence or addition of one or more other features, integers, operations, constituent elements, and components, or groups thereof. As used here, the terms “and/or” include any one or all combinations of the items which are associated and listed.

Terms including as first, second, A, B, and the like are used for describing various constituent elements, but the constituent elements are not limited by the terms. These terms are just intended to distinguish the components from other components, and the terms do not limit the nature, sequence, or order of the components.

It should be understood that, when it is described that a component is “connected to” or “accesses” another component, the component may be directly connected to or access the other component or a third component may be present therebetween throughout the specification. In contrast, it should be understood that, when it is described that a component is “directly connected to” or “directly accesses” another component, it is understood that no element is present between the element and another element.

Throughout the specification, used terms are used only to describe specific exemplary embodiments, and are not intended to limit the present invention. A singular form includes a plural form if there is no clearly opposite meaning in the context.

Additionally, it is appreciated that one or more or at least one of the following methods or aspects thereof can be executed by one or more controllers. The term “controller” may refer to a hardware device including a memory and a processor. The memory is configured to store program instructions, and the processor is particularly programmed to execute the program instructions in order to perform one or more processes which are described below in more detail. As disclosed here, the controller may control units, modules, parts, devices, or operations of those similar thereto. Further, as recognized by those skilled in the art, it is appreciated that the following methods may be executed by a device including the controller jointly with one or more other components.

Hereinafter, a method for assembling magnets using Halbach magnetic fields and an equipment thereof according to exemplary embodiments of the present invention will be described in detail with reference to drawings.

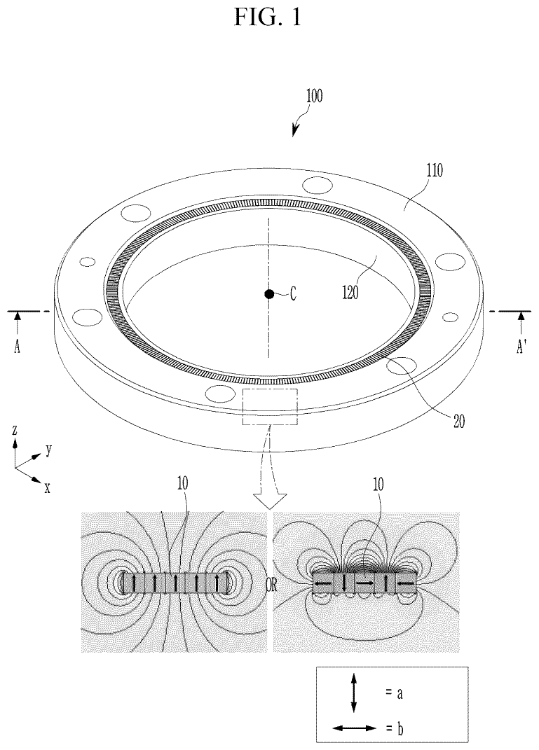

FIG. 1 illustrates a magnet assembling equipment using Halbach array magnetic fields according to an exemplary embodiment of the present invention.

Referring to FIG. 1, the magnet assembling equipment 100 using Halbach array magnetic fields according to an exemplary embodiment of the present invention includes an alignment jig 110 forming a Halbach array magnetic field through a large quantity of permanent magnets 10 fixedly disposed in a cylindrical shape, and an array jig 120 coupled to the alignment jig 110 around a rotary axis c, and capable of assembling a plurality of assembly magnets 20 (hereinafter, referred to as “magnets” for convenience) magnetized by using characteristics of the Halbach array magnetic field.

The large quantity of permanent magnets 10 disposed in the alignment jig 110 form the Halbach array magnetic field using any one of the 8-division, 6-division, and 4-division methods. In addition, the plurality of magnets 20 assembled to the array jig 120 are assembled in a specified assembly order considering an inter-magnet interaction and characteristics of the magnetic field according to any one of the 8-division, 6-division, and 4-division methods.

Here, the alignment jig 110 may be constituted by an outside diameter (OD) alignment jig or an inside diameter (ID) alignment jig forming magnetic fields concentrated on an inside direction according to an inner rotor or an outer rotor.

The OD alignment jig and the ID alignment jig are similar to each other in that both alignment jigs have a similar structure in which the large quantity of permanent magnets 10 are disposed.

However, as illustrated in FIG. 1, the OD alignment jig forms the Halbach array magnetic fields concentrated (reinforced) in an inside/rotary axis (c) direction, and the array jig 120 is assembled to an inside diameter thereof. Contrary to this, the ID alignment jig has a structure in which Halbach array magnetic fields concentrated on an outside direction are formed, and the array jig 120 is assembled to an outside diameter thereof.

Hereinafter, in regard to the alignment jig 110 according to an exemplary embodiment of the present invention, a magnet assembling method to which the OD alignment jig 110 is applied according to the inner rotor will be primarily described. However, as described above, the exemplary embodiment of the present invention is not limited thereto, but the ID alignment jig is applicable.

The magnet 20 assembled to the array jig 120 adopts a pre-magnetized permanent magnet.

The alignment jig 110 is made of an iron (Fe) material and generates an attraction of fixing a location upon assembling the magnet 20.

The array jig 120 may be manufactured by non-magnetic metal such as iron (Fe) or aluminum (Al).

The Halbach array is a technology that maximizes an intensity of magnetism in one direction, and has a characteristic that the magnetic fields are concentrated on the outside (outside diameter) or inside (inside diameter) direction of the alignment jig 110 according to a placement method of the permanent magnets 10.

Since a magnetic intensity to the outside should be maximized through the Halbach array in the case of the inner rotor, the Halbach array magnetic fields are made to be concentrated on the inside (inside diameter) direction in the case of the OD alignment jig 110 applied to the inner rotor. Accordingly, even the array jig 120 manufactured by the same iron as the OD alignment jig 110 has a characteristic that the assembled magnet 20 is attached to the outside diameter (OD) stronger than the inside diameter.

In an exemplary embodiment of the present invention, a magnet assembling method using the Halbach array magnetic fields using the characteristics is implemented, and the magnet assembling method is automated. For example, the magnet assembling equipment 100 using the Halbach array magnetic fields may automate tasks including coupling, separation, assembly, and transport using an automation facility 200 including a multi-joint robot, a cylinder, and an actuator.

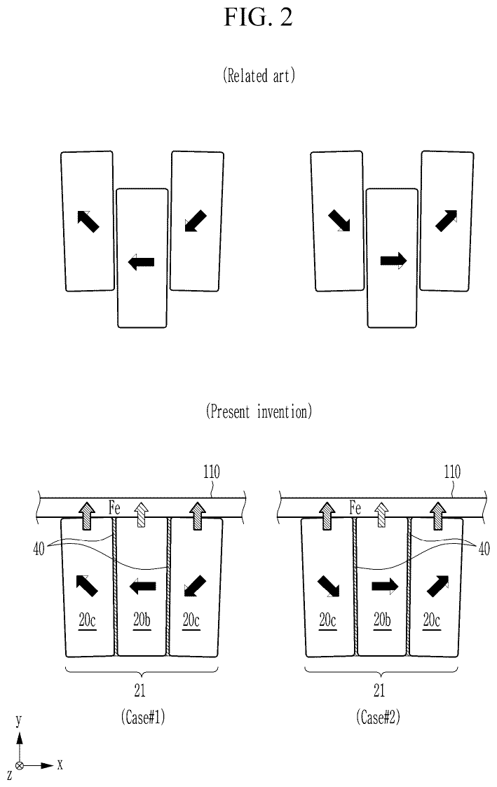

FIG. 2 illustrates a configuration example of three pieces of magnets defined when applying an 8-division Halbach array according to an exemplary embodiment of the present invention.

Referring to FIG. 2, in the case of the related art, a phenomenon occurs in which a magnet (→ ←) showing a magnetic field in a tangent direction (b) of the rotary axis (c) is pushed by an interference of magnets ( [symbol] ) (that is, an inter-magnet interaction) showing a diagonal magnetic field at both sides when the magnetized magnet is assembled in a free state (the magnetized magnets are arrayed according to the magnetic field of the magnetized magnet without an external magnetism influence) upon the 8-division Halbach array.

Therefore, the present invention is characterized in that the outside diameter of the OD alignment jig 110 is manufactured by iron (Fe) and three pieces of magnets 21 are preferentially assembled, which is configured by a combination of the remaining tangent-direction magnet 20b (e.g., → ←) except for a circumferential magnet 20a (e.g., ↑ ↓) aligned in a circumferential direction a upon the Halbach array assembling and a diagonal magnet 20c (e.g., [symbol] ). For example, as in Case #1 and Case #2, the three pieces of magnets 21 may be assembled in a structure in which the tangent-direction magnet 20b (e.g., ← or →) is assembled to a center and the diagonal magnets 20c (e.g., [symbol] or [symbol] ) corresponding to the tangent direction are arrayed at both sides. Since the three pieces of magnets 21 are pre-assembled by a bond material 40, the three pieces of magnets 21 may be referred to as “three-piece magnet assembly”. However, the three pieces of magnets 21 are referred to as the three pieces of magnets for convenience.

In this case, a force attracted by the iron (Fe) is generated in the tangent-direction magnet 20b magnetized in the tangent direction b of the rotary axis c to be in close contact with the OD alignment jig 110. Further, the diagonal magnets 20c magnetized at 45 degrees at both sides of the tangent-direction magnet 20b generate stronger magnetic fields, so the diagonal magnets 20c are in close contact with the OD alignment jig 110 more strongly. Here, as a condition for generating the force to attract the magnets to the iron (Fe), a height H of the OD alignment jig 110 is formed to be larger than a length L of the magnet 10.

The bond material 40 is applied between the magnets when coupling the three pieces of magnets 21, and all of the three pieces of magnets 21 are assembled, and then the remaining circumferential magnet 20a (e.g., ↑ ↓) is assembled. The bond material 40 is collectively cured in a final alignment state after all magnets 10 are assembled.

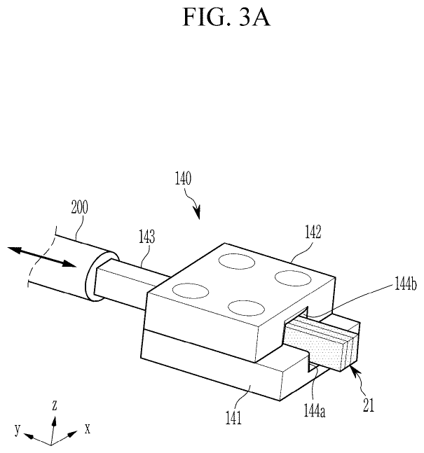

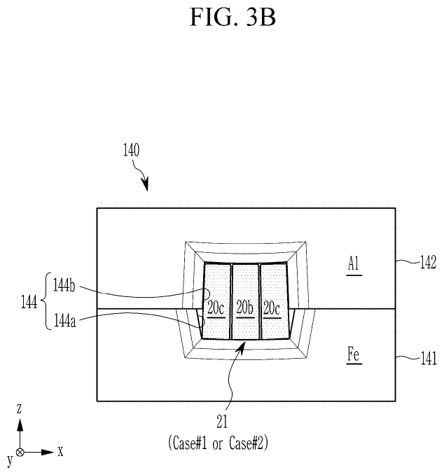

FIG. 3 (A-B) illustrates a magnet assembly unit for assembling three pieces of magnets according to an exemplary embodiment of the present invention.

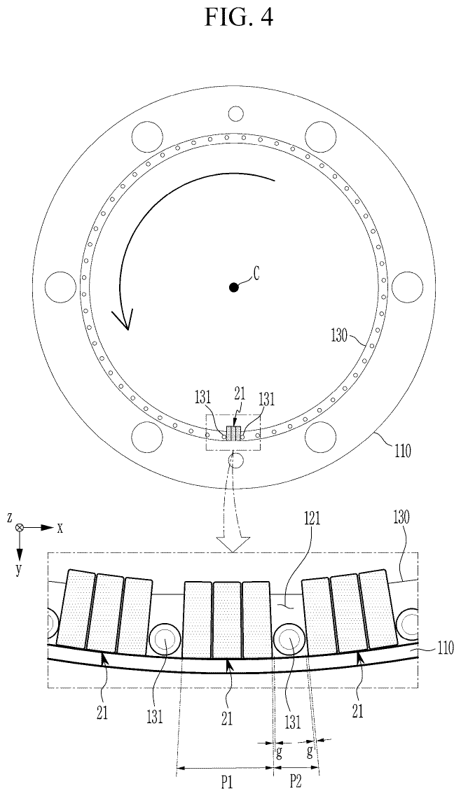

FIG. 4 illustrates a pin structure which guides assembly locations of the three pieces of magnets according to an exemplary embodiment of the present invention.

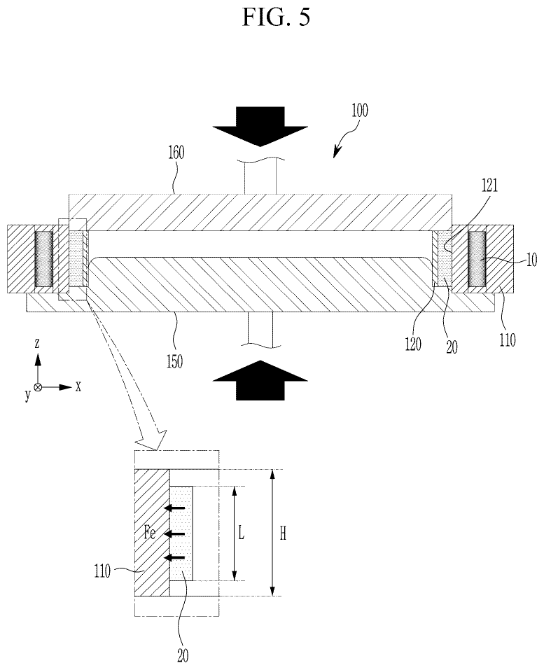

FIG. 5 is a A-A′-line cross-sectional view illustrating a final alignment state of the magnet assembled to the magnetic assembling equipment according to an exemplary embodiment of the present invention.

Referring to FIGS. 3 to 5, the magnet assembling equipment 100 using Halbach array magnetic fields according to an exemplary embodiment of the present invention may further include a pin structure 130 coupled to a placement groove 121 between the alignment jig 110 and the array jig 120 upon assembling the magnet 20, a magnet assembly unit 140 pushing and assembling the three pieces of magnets 21 except for the magnets 20a aligned in the circumferential direction a in the placement groove 121 partitioned through the pin structure 130, a support block 150 assembled to lower portions of the alignment jig 110 and the array jig 120 in a state in which all magnets 20 are assembled to the placement groove 121 after separating the pin structure 130, and a pressing block 160 pressing upper ends of all magnets 20 and finally aligning the magnets 20 according to a height of a rotor hub 170 in a state in which the support block 150 is assembled.

The magnet assembly unit 140 is a jig structure for preferentially assembling a plurality of specified magnet assemblies (e.g., three pieces of magnets) in the placement groove 121 according to a guide of the pin structure 130.

The magnet assembly unit 140 includes an assembly hole 144 formed by coupling a lower block 141 and an upper block 142, and a pusher 143 pushing the three pieces of magnets 21 assembled to the assembly hole 144, and slidably assembling the three pieces of magnets 21 to the placement groove 121.

The lower block 141 has a seating groove 144a for assembling the three pieces of magnets 21 formed on an upper surface thereof.

The upper block 142 has a guide groove 144b formed on a lower surface of a location corresponding to the seating groove 144a.

The assembly hole 144 is formed by coupling the seating groove 144a and the guide groove 144b.

The three pieces of magnets 21 having array structure Case #1 or Case #2 of FIG. 2 may be assembled to the assembly hole 144 of the magnet assembly unit 140. In this case, an assembly order of specified three pieces of magnets 21 to the assembly hole 144 is described below. First, the tangent-direction magnet 20b (e.g., ← or →) is preferentially assembled to the center. The bond material 40 is applied to both ends of the assembled tangent-direction magnet 20b. Thereafter, the diagonal magnets 20c (e.g., [symbol] or [symbol] ) are assembled in an order of a left side and a right side of the tangent-direction magnet 20b.

In the magnet assembly unit 140, the lower block 141 is manufactured by the iron (Fe), and the upper block 142 and a pusher 143 are manufactured by aluminum, for assembly of the three pieces of magnets 21 within the assembly hole 144.

A forward/backward operation of the pusher 143 is automated through the automation facility 200 such as a cylinder/actuator, so the three pieces of magnets 21 may be pushed or retreated.

The pin structure 130 has a structure in which a plurality of guide pins 131 are placed in a circular shape based on the rotary axis c.

The pin structure 130 guides an insertion location (point) of the three pieces of magnets 21 through a first assembly space P1 secured between the plurality of guide pins 131 when being coupled to the placement groove 121. In addition, upon separation, a second assembly space P2 of the circumferential magnet 20a (e.g., ↑ ↓) to be assembled is secured through a diameter size (thickness) of the guide pin 131. The diameter size of the guide pin 131 is manufactured as a size acquired by adding a width length of the circumferential magnet 20a (e.g., ↑ ↓) and a gap g of 0.05 mm or less to smoothly assemble the circumferential magnet 20a.

The pin structure 130 is rotatably coupled to the alignment jig 110 around the rotary axis c. In addition, the pin structure 130 rotates at a predetermined angle with the alignment jig 110 through a servo motor (not illustrated) to constantly maintain the insertion point of the three pieces of magnets 21 into the magnet assembly unit 140. Therefore, a uniform assembly quality may be secured.

Meanwhile, the magnet assembling method using Halbach array magnetic fields according to an exemplary embodiment of the present invention is described based on a configuration of the magnet assembling equipment 100 using Halbach array magnet fields.

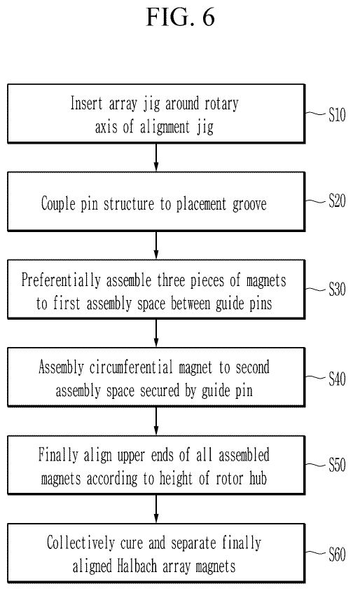

FIG. 6 is a flowchart schematically illustrating a method for assembling magnets using Halbach array magnetic fields according to an exemplary embodiment of the present invention.

Referring to FIG. 6, the magnet assembling method using Halbach array magnetic fields according to an exemplary embodiment of the present invention is configured to include a step (S10) in which the array jig 120 is assembled around the rotary axis c of the OD alignment jig 110 forming the Halbach array magnetic field through a large quantity of permanent magnets 10 fixedly placed in a cylindrical shape, a step (S20) in which the pin structure 130 in which the plurality of guide pins 131 are arrayed is placed on/in the placement groove 121 between the OD alignment jig 110 and the array jig 120, a step (S30) in which the three pieces of magnets 21 except for the circumferential magnet 20 are preferentially assembled to the first assembly space P1 partitioned by the plurality of guide pins 131 on/in the placement groove 121, a step (S40) in which the circumferential magnet 20a is assembled to the second assembly space P2 available after removing the guide pin 131 of the pin structure 130, a step (S50) in which upper ends of all magnets 20 assembled in the Halbach array are pressed to finally align all the magnets 20 according to the height of the rotor hub 170, and a step (S60) in which a bond material 40 applied between the finally aligned Halbach array magnets is collectively cured, and the Halbach magnets are separated from the OD alignment jig 110.

The bond material 40 is applied, and then the circumferential magnet 20a is assembled between the assembled three pieces of magnets 21.

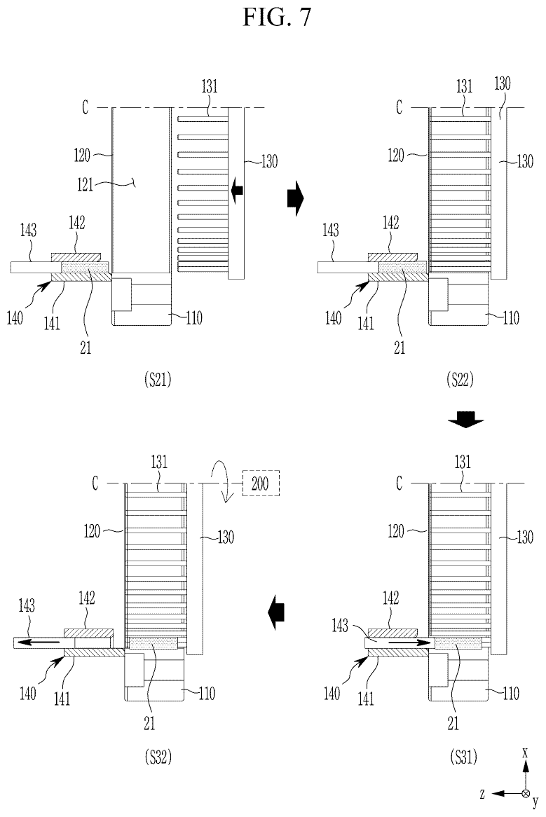

FIG. 7 illustrates a three-piece magnet assembling process using a pin structure and a magnet assembly unit according to an exemplary embodiment of the present invention.

Referring to FIG. 7, a flow which proceeds to step S20 above and step S30 above is schematized and illustrated.

First, step S20 above includes a step (S21) in which the magnet assembly unit 140 for assembling the three pieces of magnets 21 to one surface of the placement groove 121, and a step (S22) in which the pin structure 130 is coupled so that the first assembly space P1 is aligned according to assembly locations of the three pieces of magnets 21 of the magnet assembly unit 140. In other words, the pin structure 130 may be coupled so that the guide pin 131 is positioned in the second assembly space P2 to which the circumferential magnet 20a is to be assembled based on the Halbach array magnetic field formed in the OD alignment jig 110.

Next, step S30 above may include a step (S31) in which when the pin structure 130 is coupled, the three pieces of magnets 21 aligned in the magnet assembly unit 140 are pushed through the pusher 143, and slidably assembled to the first assembly space P1 of the placement groove 121, and a step (S32) in which when assembling the three pieces of magnets 21 is completed, the pusher 143 is retreated, and the pin structure 130 is rotated through the OD alignment jig 110, and then the first assembly space P1 is aligned.

In this case, the pin structure 130 is rotatably coupled by the OD alignment jig 110 or the array jig 120 having a rotor shape, and the next first assembly space P1 is rotated as large as an alignable amount based on the rotary axis c. For example, the rotation is enabled to operate through the automation facility 200 such as the servo motor.

Further, the three pieces of magnets 21 for next assembly are assembled to the magnet assembly unit 140. By repeating an assembly process of the three pieces of magnets, all three pieces of magnets 21 may be assembled to an entire first assembly space P1 partitioned through the pin structure 130.

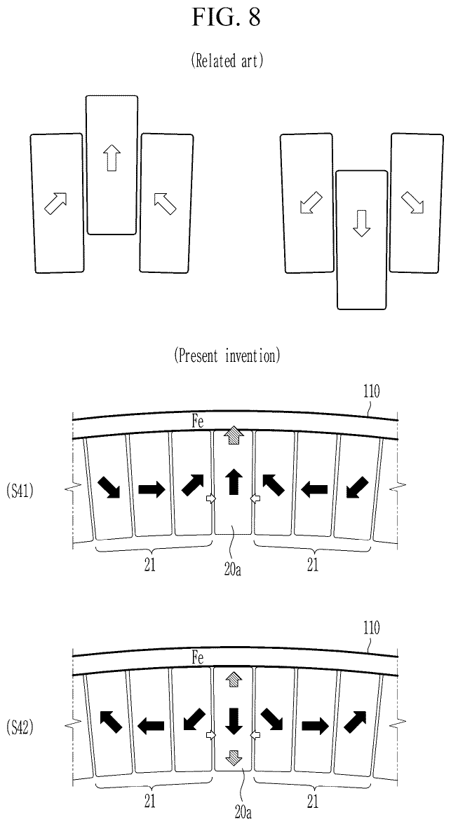

Meanwhile, FIG. 8 illustrates a process in which the three pieces of magnets are first assembled, and then a circumferential magnet is assembled according to an exemplary embodiment of the present invention.

Referring to FIG. 8, the related art shows a general 8-division Halbach array state. There is a problem in that a pushing phenomenon occurs due to an interference between both sides when assembling the circumferential magnet 20a magnetized to an outside (↑) or an inside (↓) between the diagonal magnets ( [symbol] or [symbol] ) at both sides.

Therefore, step S40 of the present invention includes a step (S41) in which all circumferential magnets 20a magnetized to the outside (↑) are pre-assembled according to a specified assembly order, and a step (S42) in which when the temporary assembly is completed, all circumferential magnets 20a magnetized to the inside (↓) are post-assembled.

According to the feature of the present invention, the circumferential magnet 20a magnetized to the outside (↑) (the outside is an N pole) may be correctly positioned by characteristics of magnetic fields formed in the OD alignment jig 110, and physical characteristics according to a reversed trapezoidal cross-sectional shape of the magnet 20, and a binding force (magnetism) by the OD alignment jig 110 manufactured by the iron (Fe). Further, in the case of the circumferential magnet 20a magnetized to the inside (↓) (the inside is the N pole), a force by the characteristics of the magnetic fields may be offset by a pushing force, and the circumferential magnet 20a may be correctly positioned by the physical characteristics, and the binding force by the OD alignment jig 110 manufactured by the iron (Fe). Here, the physical characteristics refer to characteristics in terms of hardware of the magnet 20. That is, the magnets 20 arrayed in the cylindrical shape have a reversed trapezoidal cross-sectional shape in which a bottom length is shorter than a top length which is in contact with the OD alignment jig 110. Due to such a shape (structure), the circumferential magnet 20a is fitted and coupled between three pieces of magnets 21 preferentially assembled to both sides of the circumferential magnet 20a, and a location of the circumferential magnet 20a may be physically fixed.

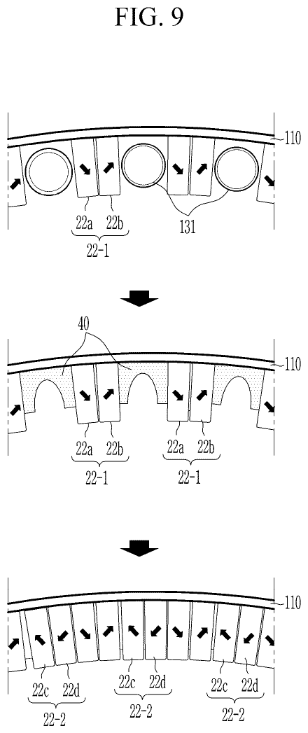

Meanwhile, FIG. 9 illustrates a final alignment and curing process of a magnet assembled in a Halbach array according to an exemplary embodiment of the present invention.

Referring to FIG. 9, a flow which proceeds to step S50 above and step S60 above is schematized and illustrated.

First, step S50 above includes a step (S51) in which the support block 150 is assembled to a lower portion of the magnet 20 assembled in the Halbach array by the OD alignment jig 110, a step (S52) in which the rotor hub 170 is bonded and assembled to the inside of the magnet 20 assembled in the Halbach array, and a step (S53) in which the upper end of the magnet 20 assembled in the Halbach array is pressed through the pressing block 160. In this case, heights of all magnets 20 are finally aligned according to the rotor hub 170 by the support block 150 assembled to the bottom of the assembled magnet 20 and a pressure of the pressing block 160 assembled to the top.

All magnets 20 are assembled by the OD alignment jig 110, and the array jig 120 is separated, and the rotor hub 170 may be assembled to a location where the array jig 120 is separated. However, the exemplary embodiment of the present invention is not limited thereto, and initially, the array jig 120 may be provided with the rotor hub 170. Accordingly, the process of assembly after the separation may be omitted.

The support block 150 and the pressing block 160 are removed after completing the final alignment.

Next, step S60 above includes a step (S61) in which the magnet 20 and the rotor hub 170 of which final alignment is completed while the magnet 20 and the rotor hub 170 are assembled to the OD alignment jig 110 are input into the oven 300, and collectively cured, and a step (S62) of separating a Halbach array magnet assembly 30 integrally manufactured by crossing the OD alignment jig 110 cooled after the curing with the pressing block 160.

The oven 300 cures the bond material 40 which is bonding-processed between the magnets 20 fixed by the magnetic fields of the OD alignment jig 110 and the rotor hub 170. For example, the bond material 40 may be provided as a resin, and cured according to a set resin curing condition (e.g., a condition such as UV, etc.).

The Halbach array magnet assembly 30 may be manufactured in a ring structure like the rotor hub 170 attached to the inside, and utilized for manufacturing the driving motor for the electric vehicle and various motors.

While the exemplary embodiments of the present invention have been described hereinabove, the present invention is not limited only the exemplary embodiments and various other changes can be made.

For example, the exemplary embodiment of the present invention is described by assuming the OD alignment jig 110 applied to the inner rotor. However, the exemplary embodiment of the present invention is not limited thereto, and may be described by assuming the ID alignment jig 110 applied to the outer rotor.

Since a magnetic intensity to the outside should be maximized through the Halbach array in the case of the outer rotor, the Halbach array magnetic fields are made to be concentrated on the outside (outside diameter) direction in the case of the ID alignment jig 110 applied to the outer rotor. In addition, the plurality of magnets 20 are enabled to be assembled according to an alignment in a state in which the cylindrical array jig 120 is coupled to the outside of the ID alignment jig 110.

Further, the exemplary embodiment of the present invention is described by specifying an order of pre-assembling the magnets magnetized to the outside (↑) and post-assembling the magnets magnetized to the inside (↓) when assembling the circumferential magnet 20a after preferentially assembling the three pieces of magnets by assuming the 8-division Halbach array.

However, the exemplary embodiment of the present invention is not limited to the 8 division, and the magnets may be assembled by specifying the assembly order considering the inter-magnet interaction and the characteristics of the magnetic fields applied for each of the 4-division and 6-division Halbach array methods.

Hereinafter, since an additional exemplary embodiment of the present invention to be described may be carried out based on the magnet assembling equipment 100 using Halbach array magnetic fields, a duplicated description is omitted and another point is primarily described.

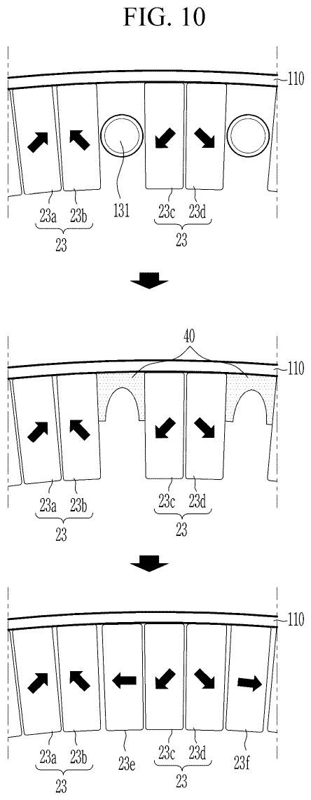

First, FIG. 10 illustrates a Halbach array assembly order upon 4 division according to a first additional exemplary embodiment of the present invention.

Referring to FIG. 10, the 4-division Halbach array according to the first additional exemplary embodiment of the present invention includes first to fourth polar magnets 22a to 22d having different magnetization directions.

In this case, in an assembly order considering an interaction between the magnets 22a to 22d and characteristics of magnetic fields, 1_2^{nd} pieces of magnets 22-1 are preferentially assembled, which is configured by a combination (e.g., [symbol] ) of the first polar magnet 22a and the second polar magnet 22b is assembled to a space partitioned by the guide pin 131.

The bond material 40 is applied to a space between the 1_2^{nd} pieces of magnets 22-1 from which the guide pin 131 is removed.

Thereafter, 2_2^{nd} pieces of magnets configured by a combination (e.g., [symbol] ) of a third polar magnet 22c and the fourth polar magnet 22d may be assembled to the space between the 1_2^{nd} pieces of magnets 22-1.

Here, the guide pin 131 may be manufactured at an array interval and with a diameter size for securing assembly spaces of the 1_2^{nd} pieces of magnets 22-1 and the 2_2 pieces of magnets 22_2.

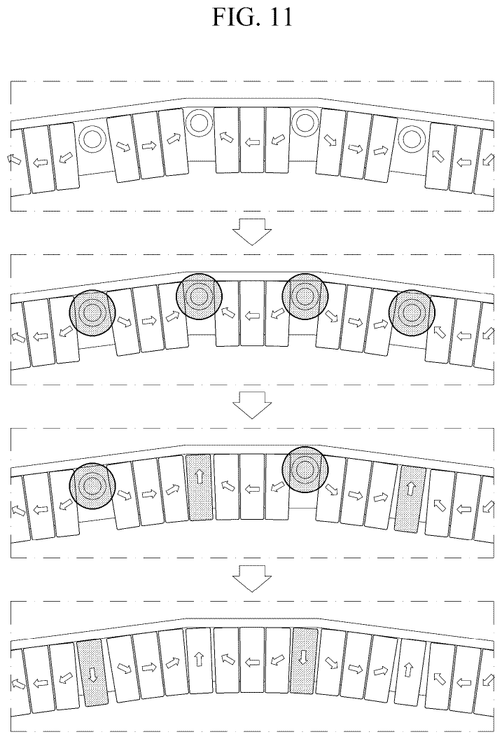

Next, FIG. 11 illustrates a Halbach array assembly order upon 6 division according to a second additional exemplary embodiment of the present invention.

Referring to FIG. 11, the 6-division Halbach array according to the second additional exemplary embodiment of the present invention includes first to sixth polar magnets 23a to 23f having different magnetization directions.

In this case, in an assembly order considering an interaction between the magnets 23a to 23f and characteristics of magnetic fields, 2 pieces of magnets 23 are preferentially assembled to the space partitioned by the guide pin 131, which are configured by a combination (e.g., [symbol] or [symbol] ) of diagonal magnets 23a+23b and 23c+23d which are symmetric to each other.

The bond material 40 is applied to a space between the 2 pieces of magnets 23 from which the guide pin 131 is removed.

Thereafter, magnets 23e and 23f in different tangent directions b may be assembled to the 2 pieces of magnets 23.

Here, the guide pin 131 may be manufactured at an array interval and a diameter size for securing assembly spaces of the 2 pieces of magnets 23 and the magnets 23e and 23f in the tangent direction b.

According to exemplary embodiments of the present invention, there is an effect in that a magnet is assembled in a stabilized state due to Halbach array magnetic field characteristics formed in a cylindrical alignment jig and physical characteristics of a magnet to easily manufacture a Halbach array magnet assembly without interference between magnets.

Further, there is an effect in that a magnet assembling process utilizing a fin structure and a magnet assembly unit and an optimal alignment bond curing process of an assembled magnet are automated to enhance productivity according to shortening a manufacturing time.

Further, there is an effect in that an assembly order considering an interaction between magnets and characteristics of a magnetic field is specified for each of 8-division, 6-division, and 4-division Halbach array methods to stably assemble the magnets without shape transformation of the assembled magnet.

The exemplary embodiments of the present invention are not limited to the above-described apparatus and/or method, but may be implemented through a program for implementing functions corresponding to the configuration of the exemplary embodiment of the present invention, a recording medium on which the program is recorded, and the like and the present invention can be easily implemented by those skilled in the art from the description of the exemplary embodiments described above.

While the exemplary embodiments of the present invention have been described above in detail, it is to be understood that the scope of the present invention is not limited to the disclosed exemplary embodiments, but, on the contrary, is intended to cover various modifications and equivalent arrangements included within the spirit and scope of the appended claims.

What is claimed is:

1. A method for assembling magnets, the method comprising:
assembling an array jig and an alignment jig, the alignment jig having a cylindrical shape with a rotary axis;
placing a plurality of guide pins in a placement groove formed between the alignment jig and the array jig, the plurality of guide pins forming a pin structure;
placing a plurality of magnets at first assembly spaces between the plurality of guide pins in the placement groove;
removing the plurality of guide pins from the placement groove providing second assembly spaces;
placing circumferential magnets at the second assembly spaces;
pressing upper ends of the plurality of magnets and the circumferential magnets to align all array magnets according to a specified height;
curing a bonding material between the aligned array magnets; and
separating the alignment jig from the array magnets.

2. The method of claim 1, further comprising:
aligning a magnet assembly unit on one surface of the placement groove, and
aligning the magnet assembly unit with the pin structure so that the magnet assembly unit places a set of magnets in a first one of the first assembly spaces located between two neighboring pins of the pin structure.

3. The method of claim 2, wherein placing the plurality of magnets at first assembly spaces in the placement groove comprises:
sliding, by a pusher of the magnet assembly unit, the set of magnets to the first one of the first assembly spaces in the placement groove,
after completing the placement of the set of magnets to the first one of the first assembly spaces, retreating the pusher,
rotating the pin structure, and
aligning the magnet assembly unit with a second one of the first assembly spaces.

4. The method of claim 3,
wherein the pin structure is rotatably coupled by a rotor-shaped alignment jig or a rotor-shaped array jig, and
wherein the pin structure is rotated with respect to the rotary axis.

5. The method of claim 1, further comprising, after placing a first set of magnets at a first assembly space, applying the bond material between the first set of magnets.

6. The method of claim 1, wherein placing the circumferential magnets in the second assembly spaces comprises:
first placing circumferential magnets magnetized to an outside according to a specified assembly order, and
after completing a first placement, secondly placing all circumferential magnets magnetized to an inside.

7. The method of claim 1, wherein pressing the upper ends of the plurality of magnets and the circumferential magnets comprises:
placing a support block to a lower portion of the array magnets,
bonding a rotor hub to an inside of the array magnets, and
pressing, by a pressing block, the upper ends of the array magnets.

8. The method of claim 7, wherein separating the alignment jig from the array magnets comprises:
placing the aligned array magnets and the rotor hub into an oven,
collectively curing the aligned array magnets and the rotor hub, and
separating the alignment jig.

9. A system comprising:
an alignment jig configured to form a Halbach array magnetic field through a plurality of permanent magnets arranged in a cylindrical shape;
an array jig coupled to the alignment jig with respect to a rotary axis of the alignment jig; and
a plurality of magnets magnetized according to the Halbach array magnetic field in a Halbach array.

10. The system of claim 9,
wherein the plurality of permanent magnets configured to form the Halbach array magnetic field are based on one of a 8-division, a 6-division, or a 4-division method, and
wherein the plurality of magnets comprises an assembly order based on an inter-magnetic interaction and characteristic of the magnetic field according to one of the 8-division, the 6-division, or the 4-division method.

11. The system of claim 9,
wherein the alignment jig is an outside diameter (OD) alignment jig configured to form magnetic fields concentrated on an inside direction according to an inner rotor, or
wherein the alignment jig is an inside diameter (ID) alignment jig configured to form magnetic fields concentrated on an outside direction according to an outer rotor.

12. The system of claim 9, wherein the alignment jig comprises an iron (Fe) material.

13. The system of claim 9, further comprising:
a pin structure coupled to a placement groove between the alignment jig and the array jig upon assembling the magnet;
a magnet assembly unit pushing and assembling three pieces of magnets except for magnets aligned in a circumferential direction a to the placement groove partitioned through the pin structure;
a support block assembled to lower portions of the alignment jig and the array jig in a state in which all magnets are assembled to the placement groove after separating the pin structure; and
a pressing block pressing upper ends of all magnets in a state in which the support block is assembled to finally align all magnets according to a height of a rotor hub.

14. The system of claim 13, wherein the magnet assembly unit comprises:
an assembly hole formed between a lower block and an upper block, and
a pusher configured for sliding a set of magnets through the assembly hole and to the placement groove.

15. The system of claim 14,
wherein the lower block has a seating groove for assembling the set of magnets on an upper surface,
wherein the upper block has a guide groove on a lower surface at a location corresponding to the seating groove, and
wherein the assembly hole is formed by coupling the seating groove and the guide groove.

16. The system of claim 14,
wherein the set of magnets comprises three pieces of magnets,
wherein a tangent-direction magnet is located at a center,
wherein a bond material is applied to both ends of the tangent-direction magnet, and
wherein diagonal magnets are arranged to a left side and a right side of the tangent-direction magnet.

17. The system of claim 14, wherein the lower block is made of iron (Fe), and the upper block and the pusher are made of aluminum.

18. The system of claim 13, wherein the pin structure includes a plurality of guide pins arranged in a circular shape around the rotary axis.

19. The system of claim 18, wherein the pin structure guides insertion locations of three pieces of magnets through a first assembly space secured between the plurality of guide pins when being coupled to the placement groove, and secures a second assembly space of the circumferential magnet to be assembled through a diameter size of the guide pin upon separation.

20. The system of claim 13, wherein the pin structure is rotatably coupled to the alignment jig around the rotary axis, and is rotatable at a predetermined angle with the alignment jig to provide insertion points of a set of magnets for the magnet assembly unit.
